(19) United States
(12) Patent Application Publication
(10) Pub. No.: US 2025/0351026 A1
(43) Pub. Date: Nov. 13, 2025

(54) SIGNALING FOR RADIO LINK FAILURE PREDICTIONS

(71) Applicant: QUALCOMM Incorporated, San Diego, CA (US)

(72) Inventors: Punyaslok PURKAYASTHA, San Diego, CA (US); Aziz GHOLMIEH, Del Mar, CA (US); Rajeev KUMAR, San Diego, CA (US); Arumugam CHENDAMARAI KANNAN, San Diego, CA (US); Ozcan OZTURK, San Diego, CA (US)

(21) Appl. No.: 19/200,389

(22) Filed: May 6, 2025

Related U.S. Application Data
(60) Provisional application No. 63/645,815, filed on May 10, 2024.

(51) Int. Cl. H04W 36/00; H04L 41/16

(52) U.S. Cl. CPC H04W 36/0079; H04L 41/16

(57) ABSTRACT

In some examples of the techniques described herein, a user equipment (UE) may utilize an artificial intelligence (AI) model to predict whether radio link failure (RLF) will occur. For instance, a network entity may configure the UE to report a prediction of the occurrence of a RLF based on beam or cell-level measurements performed on the cell. In some approaches, the configuration may include a time of prediction for RLF and one or more thresholds or conditions for triggering the report. The UE may utilize the configuration(s) to predict a probability of RLF and to report the prediction if the one or more thresholds or conditions are satisfied. The prediction may be utilized to trigger the measurement or configuration of one or more candidate cells for a potential handover. Configuring the UE to predict whether RLF will occur may enable flexibility in how an AI model is utilized.

### CROSS REFERENCE

This patent application claims the benefit of U.S. Provisional Patent Application No. 63/645,815 by PURKAYASTHA et al., entitled “SIGNALING FOR RADIO LINK FAILURE PREDICTIONS,” filed May 10, 2024, assigned to the assignee hereof, and expressly incorporated herein.

### FIELD OF TECHNOLOGY

The following relates to wireless communications, including signaling for radio link failure predictions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) for wireless communications is described. The method may include receiving, from a network entity, configuration information indicating at least one configuration for generating a prediction for radio link failure (RLF) of a link between the UE and the network entity, receiving, from the network entity, a signal for generating a measurement of the signal, and transmitting, to the network entity, an indication of the prediction for RLF of the link between the UE and the network entity, where the prediction is generated based on the measurement of the signal and an artificial intelligence (AI) model.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive, via the transceiver, from a network entity, configuration information indicating at least one configuration for generating a prediction for RLF of a link between the UE and the network entity, receive, via the transceiver from the network entity, a signal for generating a measurement of the signal, and transmit, via the transceiver to the network entity, an indication of the prediction for RLF of the link between the UE and the network entity, where the prediction is generated based on the measurement of the signal and an AI model.

Another UE for wireless communications is described. The UE may include means for receiving, from a network entity, configuration information indicating at least one configuration for generating a prediction for RLF of a link between the UE and the network entity, means for receiving, from the network entity, a signal for generating a measurement of the signal, and means for transmitting, to the network entity, an indication of the prediction for RLF of the link between the UE and the network entity, where the prediction is generated based on the measurement of the signal and an AI model.

A non-transitory computer-readable medium storing code is described. The code may include instructions executable by one or more processors to receive, from a network entity, configuration information indicating at least one configuration for generating a prediction for RLF of a link between the UE and the network entity, receive, from the network entity, a signal for generating a measurement of the signal, and transmit, to the network entity, an indication of the prediction for RLF of the link between the UE and the network entity, where the prediction is generated based on the measurement of the signal and an AI model.

In some examples of the method, UEs, and non-transitory computer-readable medium described herein, the at least one configuration for generating the prediction for RLF includes a time of the prediction for RLF, a threshold for a score based on a probability of RLF, a threshold for the measurement of the signal, or a combination thereof.

In some examples of the method, UEs, and non-transitory computer-readable medium described herein, transmitting the indication of the prediction may include operations, features, means, or instructions for transmitting, for the time of the prediction, the indication of the prediction based on a first satisfaction of the threshold for the score based on the probability of RLF and a second satisfaction of the threshold for the measurement of the signal.

In some examples of the method, UEs, and non-transitory computer-readable medium described herein, the at least one configuration includes a first configuration for a first quantity of candidate cells and a second configuration for a second quantity of candidate cells and the first quantity of candidate cells may be less than the second quantity of candidate cells.

In some examples of the method, UEs, and non-transitory computer-readable medium described herein, the first configuration includes a first time of the prediction for RLF, a first threshold for a score based on a probability of RLF, and a first threshold for the measurement of the signal and the second configuration includes a second time of the prediction for RLF and a second threshold for the score based on the probability of RLF.

In some examples of the method, UEs, and non-transitory computer-readable medium described herein, the first time of the prediction of the first configuration may be greater than the second time of the prediction of the second configuration.

In some examples of the method, UEs, and non-transitory computer-readable medium described herein, the indication of the prediction for RLF includes a predicted time for RLF, information associated with a distribution of predicted time for RLF, or a combination thereof.

Some examples of the method, UEs, and non-transitory computer-readable medium described herein may further include operations, features, means, or instructions for transmitting measurement information indicating the measurement of the signal, prediction information indicating a predicted measurement for a future occurrence of RLF, or a combination thereof.

Some examples of the method, UEs, and non-transitory computer-readable medium described herein may further include operations, features, means, or instructions for transmitting, in a message including the indication of the prediction for RLF, information indicating one or more candidate cells for handover, and one or more predicted measurements for each of the one or more candidate cells.

Some examples of the method, UEs, and non-transitory computer-readable medium described herein may further include operations, features, means, or instructions for receiving, from the network entity in response to transmitting the message, configuration data indicating a configuration for measurement of one or more additional candidate cells.

Some examples of the method, UEs, and non-transitory computer-readable medium described herein may further include operations, features, means, or instructions for receiving, from the network entity in response to the message, one or more configurations corresponding to at least one candidate cell for handover.

Some examples of the method, UEs, and non-transitory computer-readable medium described herein may further include operations, features, means, or instructions for transmitting, to the network entity, a second indication of a second prediction for RLF of the link between the UE and the network entity, where the indication of the prediction for RLF and the second indication of the second prediction for RLF may be transmitted in accordance with a period.

A method by a network entity for wireless communications is described. The method may include outputting, to a UE, configuration information indicating at least one configuration for generating a prediction for RLF of a link between the UE and the network entity, outputting, to the UE, a signal for generating a measurement of the signal, and obtaining, from the UE, an indication of the prediction for RLF of the link between the UE and the network entity, where the prediction is generated based on the measurement of the signal and an AI model.

A network entity for wireless communications is described. The network entity may include one or more memories storing processor executable code, and one or more processors coupled with the one or more memories. The one or more processors may individually or collectively be operable to execute the code to cause the network entity to output, to a UE, configuration information indicating at least one configuration for generating a prediction for RLF of a link between the UE and the network entity, output, to the UE, a signal for generating a measurement of the signal, and obtain, from the UE, an indication of the prediction for RLF of the link between the UE and the network entity, where the prediction is generated based on the measurement of the signal and an AI model.

Another network entity for wireless communications is described. The network entity may include means for outputting, to a UE, configuration information indicating at least one configuration for generating a prediction for RLF of a link between the UE and the network entity, means for outputting, to the UE, a signal for generating a measurement of the signal, and means for obtaining, from the UE, an indication of the prediction for RLF of the link between the UE and the network entity, where the prediction is generated based on the measurement of the signal and an AI model.

A non-transitory computer-readable medium storing code is described. The code may include instructions executable by one or more processors to output, to a UE, configuration information indicating at least one configuration for generating a prediction for RLF of a link between the UE and the network entity, output, to the UE, a signal for generating a measurement of the signal, and obtain, from the UE, an indication of the prediction for RLF of the link between the UE and the network entity, where the prediction is generated based on the measurement of the signal and an AI model.

In some examples of the method, network entities, and non-transitory computer-readable medium described herein, the at least one configuration for generating the prediction for RLF includes a time of the prediction for RLF, a threshold for a score based on a probability of RLF, a threshold for the measurement of the signal, or a combination thereof.

In some examples of the method, network entities, and non-transitory computer-readable medium described herein, the at least one configuration includes a first configuration for a first quantity of candidate cells and a second configuration for a second quantity of candidate cells and the first quantity of candidate cells may be less than the second quantity of candidate cells.

In some examples of the method, network entities, and non-transitory computer-readable medium described herein, the first configuration includes a first time of the prediction for RLF, a first threshold for a score based on a probability of RLF, and a first threshold for the measurement of the signal and the second configuration includes a second time of the prediction for RLF and a second threshold for the score based on the probability of RLF.

Some examples of the method, network entities, and non-transitory computer-readable medium described herein may further include operations, features, means, or instructions for obtaining, in a message including the indication of the prediction for RLF, information indicating one or more candidate cells for handover, and one or more predicted measurements for each of the one or more candidate cells.

Some examples of the method, network entities, and non-transitory computer-readable medium described herein may further include operations, features, means, or instructions for outputting, to the UE in response to the message, configuration data indicating a configuration for measurement of one or more additional candidate cells.

Some examples of the method, network entities, and non-transitory computer-readable medium described herein may further include operations, features, means, or instructions for outputting, to the one or more candidate cells in response to the message, information associated with a potential handover of the UE to the one or more candidate cells and outputting, to the UE in response to the message, one or more configurations corresponding to at least one candidate cell for handover.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports signaling for radio link failure (RLF) predictions in accordance with one or more aspects of the present disclosure.

FIG. 2 shows an example of a wireless communications system that supports signaling for RLF predictions in accordance with one or more aspects of the present disclosure.

FIG. 3 shows an example of a graph that supports signaling for RLF predictions in accordance with one or more aspects of the present disclosure.

FIG. 4 shows an example of a process flow that supports signaling for RLF predictions in accordance with one or more aspects of the present disclosure.

FIG. 5 shows an example of a block diagram of a machine learning process that supports signaling for RLF predictions in accordance with one or more aspects of the present disclosure.

FIGS. 6 and 7 show block diagrams of devices that support signaling for RLF predictions in accordance with one or more aspects of the present disclosure.

FIG. 8 shows a block diagram of a communications manager that supports signaling for RLF predictions in accordance with one or more aspects of the present disclosure.

FIG. 9 shows a diagram of a system including a device that supports signaling for RLF predictions in accordance with one or more aspects of the present disclosure.

FIGS. 10 and 11 show block diagrams of devices that support signaling for RLF predictions in accordance with one or more aspects of the present disclosure.

FIG. 12 shows a block diagram of a communications manager that supports signaling for RLF predictions in accordance with one or more aspects of the present disclosure.

FIG. 13 shows a diagram of a system including a device that supports signaling for RLF predictions in accordance with one or more aspects of the present disclosure.

FIGS. 14 through 17 show flowcharts illustrating methods that support signaling for RLF predictions in accordance with one or more aspects of the present disclosure.

### DETAILED DESCRIPTION

In some wireless communications systems, a network entity may communicate with a user equipment (UE) via a radio link. In some scenarios due to UE mobility, blockage, or radio frequency (RF) signal attenuation, a radio link failure (RLF) may occur. For instance, a signal from a network entity may be attenuated or blocked to a degree that the UE may be unable to successfully receive or decode the signal.

Some examples of the techniques described may provide network configuration and UE reporting of RLF predictions based on an artificial intelligence (AI) model or machine learning (ML) model at a UE. As used herein, the term “AI model” may refer to an AI model with ML, an ML model, or a non-ML AI model. An AI model is a structure (e.g., data structure, program, or algorithmic structure) capable of being trained using data (e.g., training input data, ground truth data) to predict one or more outputs. For instance, training input data and corresponding ground truth data that represents one or more target outputs may be utilized for a training the AI model. During training, the AI model or ML model may be executed using the training input data to predict outputs, where the AI model or ML model is adjusted to reduce a cost (e.g., a difference between the predicted outputs and the ground truth data). For instance, one or more weights of the AI model or ML model may be adjusted to reduce a cost produced by a cost function (based on the predicted outputs and the ground truth data, for instance). During application (e.g., prediction, runtime, or inferencing), the AI model may be executed using input data (e.g., real-world data or runtime data that is different from the training input data).

In some examples of the techniques described herein, a UE may utilize an AI model to predict whether RLF will occur. For instance, a network entity may configure the UE to report a prediction of the occurrence of a RLF based on beam or cell-level measurements performed on the cell. In some approaches, the configuration may include a time of prediction for RLF and one or more thresholds or conditions for triggering the report. The UE may utilize the configuration(s) to predict a probability of RLF and to report the prediction if the one or more thresholds or conditions are satisfied. The prediction may be utilized to trigger the measurement or configuration of one or more candidate cells for a potential handover.

Configuring the UE to predict whether RLF will occur may enable flexibility in how an AI model is utilized at the UE. For instance, the UE may be configured to indicate different quantities of predictions for respective time periods, which may enable tuning of the processing resources utilized for prediction or the communication resources used for reporting. Additionally, or alternatively, configuring the UE may enable flexibility for different scenarios (e.g., more or fewer cells available for handover) or for changing the circumstances in which a prediction is reported. Communicating an indication of the prediction may enable a UE or network entity to perform one or more operations before RLF actually occurs, which may increase communication reliability or device coordination for handover.

Aspects of the disclosure are initially described in the context of wireless communications systems. Aspects of the disclosure are also described in the context of a graph, a process flow, and a block diagram. Aspects of the disclosure are further illustrated by and described with reference to apparatus diagrams, system diagrams, and flowcharts that relate to signaling for RLF predictions.

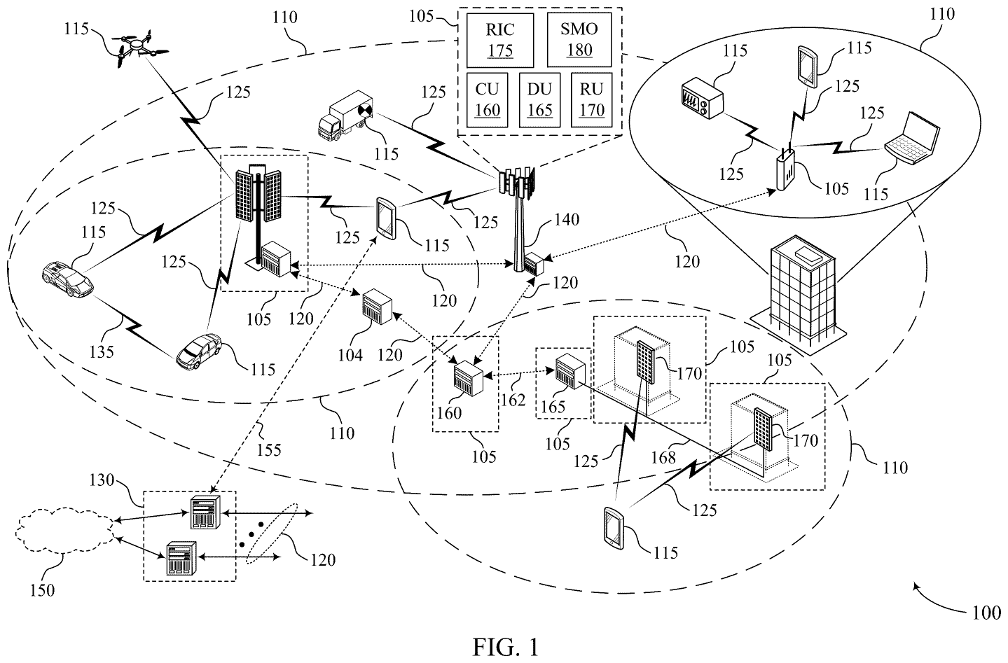

FIG. 1 shows an example of a wireless communications system 100 that supports signaling for RLF predictions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some examples of the techniques described may provide network configuration and UE 115 reporting of RLF predictions based on an AI model at a UE 115. In some examples, a UE 115 may utilize an AI model to predict whether RLF will occur. For instance, a network entity 105 may configure the UE 115 to report a prediction of the occurrence of a RLF based on beam or cell level measurements performed on the cell. In some approaches, the configuration may include a time of prediction for RLF or one or more thresholds or conditions for triggering the report. The UE 115 may utilize the configuration(s) to predict a probability of RLF and to report the prediction if the one or more thresholds are satisfied. The prediction may be utilized to trigger the measurement or configuration of one or more candidate cells for a potential handover.

Configuring the UE 115 to predict with RLF will occur may enable flexibility in how an AI model is utilized at the UE 115. For instance, the UE 115 may be configured to indicate different quantities of predictions for respective time periods, which may enable tuning of the processing resources utilized for prediction or the communication resources used for reporting. Additionally, or alternatively, configuring the UE 115 may enable flexibility for different scenarios (e.g., more or fewer cells available for handover) or for changing the circumstances in which a prediction is reported. Communicating an indication of the prediction may enable a UE 115 or network entity 105 to perform one or more operations before RLF actually occurs, which may increase communication reliability or device coordination for handover.

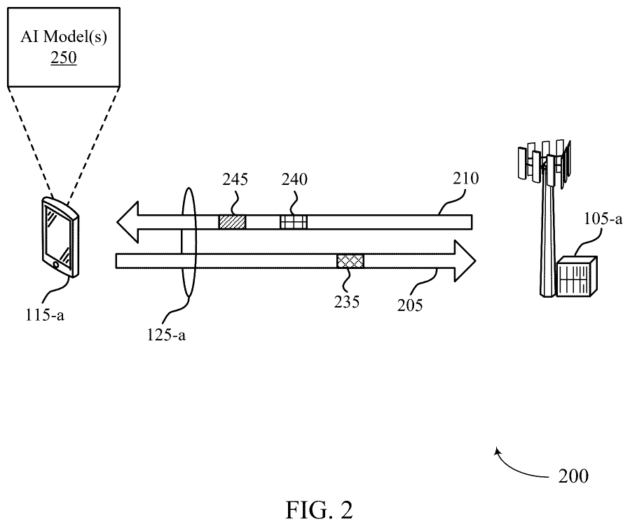

FIG. 2 shows an example of a wireless communications system 200 that supports signaling for RLF predictions in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a link 125-a, which may be an example of a communication link 125 described with respect to FIG. 1. The link 125-a may include a bi-directional link that enables uplink or downlink network communications. For example, the UE 115-a may transmit one or more uplink transmissions 205, such as uplink control signals or uplink data signals, to the network entity 105-a using the link 125-a, or the network entity 105-a may transmit one or more downlink transmissions 210, such as downlink control signals or downlink data signals, to the UE 115-a using the link 125-a.

The network entity 105-a may output (e.g., transmit), or the UE 115-a may receive, configuration information 245 indicating at least one configuration (e.g., a configuration indication) for generating a prediction for RLF of the link 125-a between the UE 115-a and the network entity 105-a. For instance, the UE 115-a may include one or more AI models 250 that may be utilized to generate a prediction for RLF of the link 125-a. A configuration for generating a prediction may include one or more parameters associated with generating a prediction for RLF using the AI model(s) 250 or associated with indicating (e.g., reporting or triggering a report of) a prediction for RLF. For example, the network entity 105-a may provide one or more sets of configurations to the UE 115-a for operating (e.g., executing) the AI model(s) 250 for RLF prediction or for triggering a report associated with a potential or predicted RLF event. In some approaches, the configuration information 245 indicating the configuration for generating a prediction may be included in a message (e.g., a control message, an RRC message, a medium access control-control element (MAC-CE), a downlink control information (DCI) message, or a data message, among other examples). Communicating configuration information 245 may enable coordination between the UE 115-a and the network entity 105-a for controlling RLF prediction or one or more communications (e.g., transmission(s) or reception(s)) related to RLF prediction.

The network entity 105-a may output (e.g., transmit), or the UE 115-a may receive, one or more signals 240 for generating one or more measurements of the one or more signals 240. Examples of the signal(s) 240 may include one or more reference signals, such as one or more demodulation reference signals (DMRSs), one or more channel state information reference signals (CSI-RSs), one or more tracking reference signals (TRSs), or other reference signals. The UE 115-a may utilize the signal(s) 240 to generate one or more measurements of the signal(s) 240. The measurement(s) may indicate one or more characteristics of the signal 240, such as signal power, signal quality, signal amplitude, signal magnitude, or signal strength. Examples of a measurement of the signal 240 may include reference signal received power (RSRP), a received signal strength indicator (RSSI), reference signal received quality (RSRQ), signal strength (in decibel-milliwatts (dBm), for instance), signal-to-noise ratio (SNR), signal-to-interference plus noise ratio (SINR), channel quality indicator (CQI), or another measurement. The communication of the one or more signals 240 may enable RLF prediction utilizing AI/ML (e.g., for obtaining input to an AI/ML model(s) for RLF prediction).

In some examples, the UE 115-a may determine (e.g., sense, calculate, or evaluate, among other examples) one or more measurements for one or more signals 240. For instance, the UE 115-a may determine one or more measurements for one or more beams utilized to transmit or receive the signal(s) 240 or may determine one or more cell-level measurements based on the signal(s) 240. Additionally, or alternatively, the UE 115-a may determine one or more current or previous measurements (e.g., historical measurement(s) or measurement(s) within a period previous to a current time, among other examples) based on one or more current or previous signals 240. The determination of the one or more measurements may enable RLF prediction utilizing AI/ML (e.g., for input to an AI/ML model(s) for RLF prediction).

The UE 115-a may generate the prediction based on the AI model(s) 250 and the measurement(s) of the signal(s) 240. For instance, the UE 115-a may utilize the measurement(s) as input to the AI model(s) 250, which may generate the prediction in accordance with the configuration. Generating the prediction may provide an indication of a potential or impending RLF, which may enable performing one or more actions to avoid or reduce the impact of RLF.

In some aspects, the AI model(s) 250 may be trained using training data, where the training data may include training input data or ground truth data. For instance, the training data may include one or more measurements of one or more signals, one or more times (after the measurement(s)), or ground truth data indicating whether RLF occurred in association with the measurement(s) or the time(s). In some examples, the AI model(s) 250 may be trained to predict a probability of RLF based on the measurement(s) and a time (e.g., a future time or a quantity of time from a current time, among other examples). Additionally, or alternatively, the AI model(s) 250 may be trained to predict a time (e.g., a future time or a quantity of time from a current time, among other examples) when a probability of RLF occurs. Additionally, or alternatively, the AI model(s) 250 may be trained to predict a probability distribution or a cumulative distribution function (CDF) that an RLF will occur at a future time or over a period (e.g., range of times). Additionally, or alternatively, the AI model(s) 250 may be trained to predict a score associated with a probability that RLF will occur at a future time or over a period (e.g., range of times). A score may be an assessment of a probability of RLF occurring. For instance, the score may be the probability that RLF will occur or may be a metric based on the probability that RLF will occur.

In some examples, the AI model(s) 250 may be trained to predict one or more future measurements. For instance, the AI model(s) 250 may be trained to predict one or more future RSRPs, RSSIs, RSRQs, signal strengths, SNRs, SINRs, CQIs, or other measurements. The one or more predicted measurements may be predicted for one or more times for prediction of the configuration for generating a prediction. The one or more predicted measurements may be predicted based on one or more measurements of the signal(s) 240.

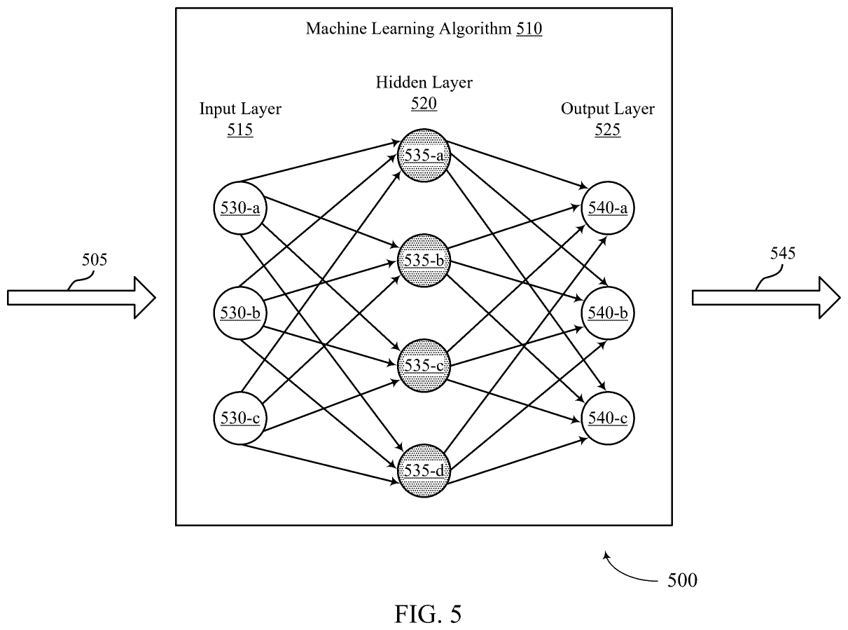

The AI model(s) 250 may be trained by the UE 115-a, by the network entity 105-a, or by another device (e.g., another network entity (ies), UE(s), or server(s) among other examples). For instance, the AI model(s) 250 may be trained by another device and may be received or stored by the UE 115-a for runtime application. In some approaches, the UE 115-a may update the training of the AI model(s) 250 based on the signal(s) 240 (e.g., measurement(s) of the signal(s)), the configuration for generating a prediction, or one or more detected RLFs. Examples of an AI model 250 may include a neural network, such as a feed forward (FF) or deep feed forward (DFF) neural network, a recurrent neural network (RNN), a long/short term memory (LSTM) neural network, or any other type of neural network. Additionally, or alternatively, examples of the AI model 250 may include a regression model, a support vector machine (SVM) model, or a K-nearest neighbor (KNN) model, among other examples. An example of an AI model 250 is described with reference to FIG. 5.

In some aspects, the UE 115-a may utilize uses the AI model(s) 250 to predict the occurrence of RLF in the future. For example, the AI model(s) 250 may utilize the measurement(s) of the signal(s) 240 (e.g., UE 115-a beam and cell measurements at one or more historical time instances), and may produce as output one or more predictions of an occurrence of RLF for the future.

The UE 115-a may transmit, or the network entity 105-a may obtain (e.g., receive), an indication 235 of the prediction (e.g., a prediction indication) for RLF of the link 125-a between the UE 115-a and the network entity 105-a. For instance, the indication 235 of the prediction may indicate a prediction of a RLF occurrence, one or more probabilities of RLF predicted by the AI model(s) 250, one or more times of RLF predicted by the AI model(s) 250, or one or more measurements predicted by the AI model(s) 250, among other examples. The indication 235 of the prediction may be transmitted via uplink control information (UCI), uplink data, one or more messages, or a combination thereof.

In some approaches, the predicted RLF occurrence may be indicated explicitly or implicitly. For instance, the indication 235 of the prediction may include an explicit indicator (e.g., a bit) to indicate whether an RLF occurrence is predicted. Additionally, or alternatively, the indication 235 of the prediction may implicitly indicate that an RLF occurrence is predicted (e.g., due to the transmission of a predicted probability of an RLF occurrence, a predicted time of an RLF occurrence, or another value, such as a predicted RSRP measurement).

In some examples, the at least one configuration for generating the prediction for RLF may include a time of the prediction for RLF, a threshold for a score based on a probability of RLF, a threshold for the measurement of the signal 240, or a combination thereof. For instance, a time of the prediction may be a future time of prediction. In some aspects, the at least one configuration may include multiple times of prediction. In some approaches, a time of prediction may be a future time for which an RLF or a probability of RLF is predicted. For example, an AI model 250 may produce a prediction (e.g., a prediction of RLF or a prediction of a probability of RLF occurring in the future) at a current time, where the prediction corresponds to the time of prediction in the future. For instance, one or more predictions of RLF may be generated at a current time before the one or more times for prediction occur in the future. In some examples, a future time of prediction may be input to the AI model(s) 250 (at a current time, for instance) to generate the prediction (before the future time of prediction) or may be utilized to select a value(s) (e.g., a probability of RLF from a CDF) from the prediction (e.g., predicted future RLF probability).

The threshold for a score based on the probability of RLF may be a threshold for a probability or score of RLF during the prediction time. In some examples, the threshold for a score may be denoted as “threshProb” or “threshScore.” In some approaches, the threshold for the score may be utilized to trigger transmission of the indication 235 of the prediction for RLF. For instance, if the score (e.g., the probability of RLF) reaches the threshold for the score, the UE 115-a may transmit the indication 235 of the prediction to the network entity 105-a in some approaches.

The threshold for the measurement of the signal 240 may be a threshold for the one or more measurements (e.g., RSRP) of the one or more signals. For instance, the threshold for the measurement may be a threshold for an RSRP of the signal 240 corresponding to a beam or cell (e.g., a serving cell) associated with the network entity 105-a. In some examples, the threshold for the measurement may be denoted as “threshRSRP.” In some approaches, the threshold for the measurement may be utilized to trigger transmission of the indication 235 of the prediction for RLF. For instance, if the measurement (e.g., the RSRP) is less than the threshold for the measurement, the UE 115-a may transmit the indication 235 of the prediction to the network entity 105-a in some approaches.

In some aspects, a predicted RLF occurrence or transmission of the indication 235 of the prediction may be triggered by the UE 115-a when one or more thresholds or conditions are satisfied. For instance, if a predicted probability of RLF (e.g., a minimum predicted probability) is greater than a threshold (e.g., threshScore or threshProb) in a quantity of time in the future (e.g., T ms), a predicted RLF occurrence or transmission of the indication 235 may be triggered. In some examples, a predicted RLF occurrence or transmission of the indication 235 of the prediction may be triggered periodically. For instance, the UE 115-a may transmit an indication of a newly determined prediction periodically. In some examples, a predicted RLF occurrence or transmission of the indication 235 of the prediction may be triggered when a first or earliest value (e.g., an earliest predicted probability of RLF) is greater than a threshold (e.g., threshScore or threshProb). In some examples, a predicted RLF occurrence or transmission of the indication 235 of the prediction may be triggered when a highest or eventual value (e.g., a highest or any predicted probability of RLF) is greater than a threshold (e.g., threshScore or threshProb). For instance, the predicted RLF occurrence or transmission of the indication 235 may be triggered if the UE 115-a determines a predicted RLF with a probability greater than 30% eventually.

In some approaches, transmitting the indication 235 of the prediction may include transmitting, for the time(s) of the prediction, the indication 235 of the prediction based on a first satisfaction of the threshold for the score based on the probability of RLF and a second satisfaction of the threshold for the measurement of the signal 240. For instance, if for the prediction time, the serving cell RSRP<threshRSRP and the score of RLF>threshProb (or threshScore), then the UE 115-a may transmit the indication 235 of the prediction (e.g., RLF report).

In some examples, the configuration information 245 indicating the configuration may indicate one or more configurations. Different configurations may include different quantities of parameters (e.g., a first configuration may include three parameters and a second configuration may include two parameters), different values for parameters (e.g., one or more different times or one or more different thresholds), or a combination thereof. Different configurations may be utilized for different scenarios, such as when fewer or more candidate cells (for potential handover) are available. For instance, the at least one configuration may include a first configuration for a first quantity of candidate cells and a second configuration for a second quantity of candidate cells. The first quantity of candidate cells may be less than the second quantity of candidate cells.

In some examples, a first configuration may be utilized for a scenario where no candidate cell or a few candidate cells (e.g., zero, one, two, or another quantity of candidate cells) are configured by the network. In some approaches, the first configuration may include a first time of the prediction for RLF (e.g., a future time of prediction), a first threshold for a score based on a probability of RLF (e.g., a first threshold for a probability or score of RLF during the prediction time, “threshProba,” or “threshScoreA”), and a first threshold for the measurement of the signal 240 (e.g., a first threshold for an RSRP of the signal 240 corresponding to a beam or cell, such as a serving cell associated with the network entity 105-a, or “threshRSRPA”). The first time(s) of the of the prediction, the first threshold for a score, or the first threshold for the measurement may be utilized for the prediction of the AI model(s) 250 or to trigger the indication 235 of the prediction as described herein, when a first condition for the first configuration (e.g., less than a threshold quantity of candidate cells) is satisfied.

In some examples, a second configuration may be utilized for a scenario where a relatively large quantity of candidate cells (e.g., three, four, five, or another quantity of candidate cells) are configured by the network. In some approaches, the second configuration may include a second time of the prediction for RLF (e.g., a future time of prediction) and a second threshold for a score based on a probability of RLF (e.g., a second threshold for a probability or score of RLF during the prediction time, “threshProbB,” or “threshScoreB”). The second time(s) of the of the prediction, or the second threshold for a score may be utilized for the prediction of the AI model(s) 250 or to trigger the indication 235 of the prediction as described herein, when a second condition for the second configuration (e.g., greater than a threshold quantity of candidate cells) is satisfied. In some aspects, the first time of the prediction of the first configuration may be greater (e.g., longer) than the second time of the prediction of the second configuration.

In some approaches, the network entity 105-a may configure the UE 115-a to trigger an event when the probability of a future RLF, in an amount of time, satisfies a threshold (e.g., the score threshold). For instance, the configuration information 245 indicating the configuration may configure the UE 115-a to transmit the indication 235 of the prediction if a predicted probability of RLF satisfies a threshold (e.g., 30% in 200 ms or 50% in 300 ms, among other examples). In a case that the threshold (e.g., the score threshold) is satisfied, the UE 115-a may transmit the indication 235 of the prediction, which may indicate the event of a predicted RLF with the one or more measurements (e.g., current measurements, such as current RSRP). Additionally, or alternatively, the UE 115-a may report one or more predicted measurements for the future.

In some examples, the indication 235 of the prediction for RLF may include a predicted time for RLF, information associated with a distribution of predicted time for RLF, or a combination thereof. In some aspects, the UE 115-a may include a predicted time of occurrence of RLF on a cell or information related to a distribution (e.g., CDF) of the predicted time in the indication 235 (e.g., a report).

In some approaches, the configuration information 245 indicating the configuration may fix a variable (e.g., one of two variables): the time(s) for prediction (e.g., time thresholds) or the probability (ies) of RLF. Additionally, or alternatively, the UE 115-a may operate in accordance with a specification that fixes a variable (e.g., one of the two variables). For example, the network entity 105-a may transmit the configuration information 245 indicating the configuration that may configure the UE 115-a to send predicted probabilities of RLF for 100 ms, 200 ms, 300 ms, or another time(s). In the indication 235 of the prediction, the UE 115-a may report 5%, 20%, and 30% probabilities of RLF corresponding to the configured times for prediction. Additionally, or alternatively, the network entity 105-a may transmit the configuration information 245 indicating the configuration that may configure the UE 115-a to send predicted times when probabilities of RLF are above 10%, 20%, 50%, or another probability (ies). In the indication 235 of the prediction, the UE 115-a may report 100 ms, 140 ms, and 180 ms for predicted times of RLF corresponding to the configured probabilities for prediction.

In some examples, the UE 115-a may transmit measurement information indicating one or more measurements of the signal 240, prediction information indicating one or more predicted measurements for a future occurrence of RLF, or a combination thereof. For instance, the indication 235 of the prediction may include, or the UE 115-a may transmit separately, measurement information indicating one or more measurements of the signal 240, prediction information indicating one or more predicted measurements for a future occurrence of RLF, or a combination thereof. In some approaches, the UE 115-a may transmit a message or report that includes one or more beam or cell measurements. The message or report may include the indication 235 of the prediction or may be separate from the indication 235 of the prediction. The beam or cell measurement(s) may include one or more current measurements (e.g., current RSRP(s)) or one or more predicted measurements at the predicted time of the occurrence of RLF. For instance, when an RLF occurrence event is triggered, the UE 115-a may report the occurrence with one or more beam or cell level measurements. Additionally, or alternatively, the UE 115-a may transmit the indication 235 of the prediction or a report including one or more predicted beam or cell level measurements for the configured quantity of time(s) for the future.

In some aspects, the UE 115-a may transmit information indicating one or more candidate cells for handover, or one or more predicted measurements for each of the one or more candidate cells. For example, the UE 115-a may transmit, in a report or message that includes the indication 235 of the prediction for RLF, the information indicating one or more candidate cells for handover, and one or more predicted measurements for each of the one or more candidate cells. For instance, an RLF report or message, the UE 115-a may include a list of suggested candidate cells for handover and may provide one or more measurements (e.g., RSRP(s)) or one or more measurement predictions (e.g., predicted RSRP(s)) of the suggested candidate cells. The predicted measurements for the one or more candidate cells may be generated by the AI model(s) 250 based on one or more measurements corresponding to the one or more candidate cells (e.g., from signals or reference signals from the one or more candidate cells).

In some examples, the network entity 105-a may output (e.g., transmit), or the UE 115-a may receive, in response to transmitting the message, configuration data indicating a configuration for measurement of one or more beams or (additional) candidate cells. For instance, based on receiving the message, the network entity 105-a (e.g., a source gNB) may provide a measurement configuration for the UE 115-a to measure one or more candidate cells in addition to the one or more previously indicated candidate cells.

Additionally, or alternatively, the network entity 105-a may output (e.g., transmit), or the UE 115-a may receive, in response to the message, one or more configurations corresponding to one or more candidate cells for handover. In some approaches, the network entity 105-a may output, or the UE 115-a may receive, in response to the message, configuration data indicating a configuration for measurement of the one or more candidate cells or one or more additional candidate cells. In some approaches, the network entity 105-a may output, to one or more candidate cells (e.g., one or more other network entities) in response to the message, information associated with a potential handover of the UE 115-a to the one or more candidate cells. The network entity 105-a may output, or the UE 115-a may receive, in response to the message, one or more configurations corresponding to one or more candidate cells for handover. For instance, based on receiving the message, the network entity 105-a (e.g., a source gNB) may initiate handover preparation of the suggested candidate cells. During or after completion of the handover preparation procedure, the network entity 105-a may provide (to the UE 115-a) the candidate cell configuration(s) for handover.

The handover may be a regular handover, a blind handover, or a conditional handover (CHO). In a blind handover, the UE 115-a may handover to a candidate cell or a frequency for which network does not have measurements from the UE 115-a. In conditional handover, the UE 115-a may determine to execute a handover if one or more conditions are satisfied (e.g., if a target cell satisfies a threshold measurement or if a measurement of the source cell falls between a threshold, among other examples).

In some examples, the UE 115-a may transmit, or the network entity 105-a may obtain, a second indication of a second prediction for RLF of the link 125-a between the UE 115-a and the network entity 105-a, where the indication 235 of the prediction for RLF and the second indication of the second prediction for RLF are transmitted in accordance with a period (e.g., periodically). For instance, The UE 115-a may provide indications of a prediction (e.g., RLF occurrence reports) periodically.

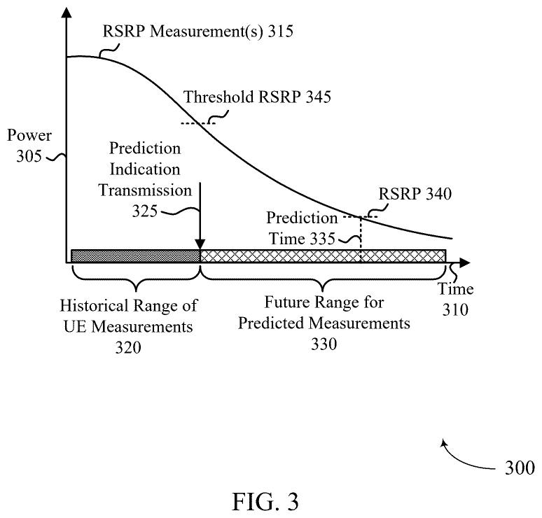

FIG. 3 shows an example of a graph 300 that supports signaling for RLF predictions in accordance with one or more aspects of the present disclosure. In particular, FIG. 3 illustrates an example of a scenario in which a UE (e.g., UE 115-a) may generate a prediction of RLF using one or more AI models and may transmit an indication of the prediction of RLF. The graph 300 is illustrated in power 305 (e.g., in dBm) over time 310 (e.g., in ms).

In the example of FIG. 3, a UE may determine (e.g., sense or calculate) a RSRP measurement(s) 315 (of a serving cell) during a historical range of UE measurements 320. For instance, the UE may receive one or more reference signals and may utilize the reference signals to determine the RSRP measurement(s) 315 during the historical range of UE measurements 320 as described with reference to FIG. 2.

Based on the RSRP measurement(s) 315 in the historical range of UE measurements 320, the UE may generate one or more predicted RSRP measurement(s) 315 in a future range for predicted measurements 330. For instance, the UE may utilize an AI model to predict a probability of RLF corresponding to an RSRP 340 at a prediction time 335 in the future. The predicted probability of RLF may indicate that RLF is likely to occur (e.g., the predicted probability satisfies threshProb) at or below the RSRP 340.

An example of a threshold RSRP 345 is illustrated in FIG. 3. The threshold RSRP 345 may be an example of threshRSRP as described with reference to FIG. 2. In the example of FIG. 3, a prediction indication transmission 325 is triggered in response to the RSRP measurement 315 declining below the threshold RSRP (e.g., threshRSRP) and the predicted probability at the prediction time 335 increasing above a threshold probability of RLF (e.g., threshProb). Accordingly, the UE may provide the prediction indication transmission 325 before the RLF actually occurs. The prediction indication transmission 325 may enable the UE or a network entity to perform one or more operations (e.g., handover, beamforming, transmission power increase, or modulation and coding scheme (MCS) order decrease, among other examples) to maintain or improve communications before RLF actually occurs. In accordance with some of the techniques described herein, a UE may report to a network (e.g., network entity) a prediction of RLF in the future (e.g., the relatively near future, such as within 50 ms, 100 ms, 200 ms, 500 ms, 1 second, 2 seconds, 5 seconds, or 10 seconds, among other examples) based on AI/ML running at the UE. The network (e.g., network entity) may configure the UE with one or more neighbor cells or one or more corresponding measurement objects, which may lead to a handover before the RLF.

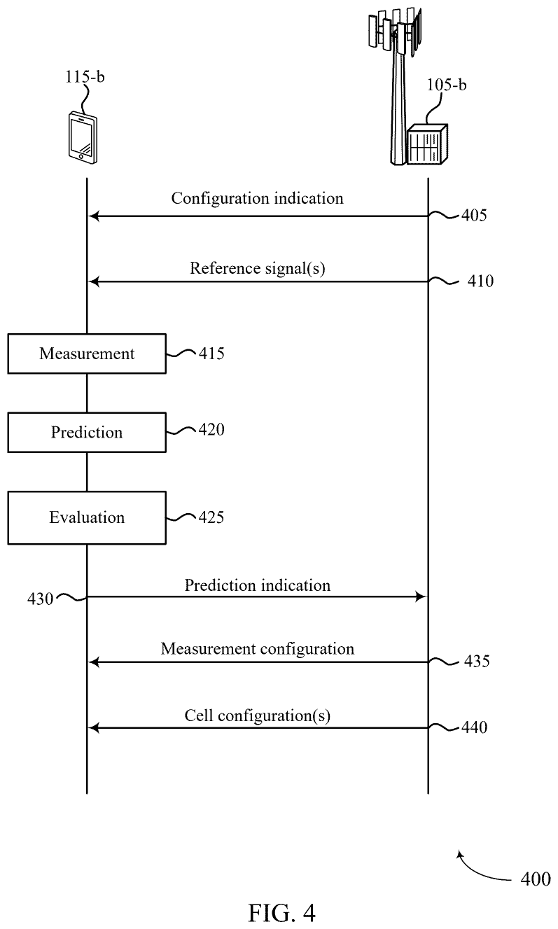

FIG. 4 shows an example of a process flow 400 that supports signaling for RLF predictions in accordance with one or more aspects of the present disclosure. A wireless communication system may include a UE 115-b and a network entity 105-b. The UE 115-b may be an example of the UEs 115 or the UE 115-a, and the network entity 105-b may be an example of the network entities 105 or the network entity 105-a, as described herein.

In the following description of the process flow 400, the communications between the network entity 105-b and the UE 115-b may be transmitted in a different order than the example order shown, or the operations performed by the network entity 105-b and the UE 115-b may be performed in different orders or at different times. One or more operations may be omitted from the process flow 400, or one or more other operations may be added to the process flow 400. Although some operations or signaling may be shown to occur at different times for discussion purposes, these operations may actually occur at the same time or in overlapping time periods in some examples.

At 405, the network entity 105-b may output a configuration indication 405 to the UE 115-b. For example, the network entity 105-b may output, or the UE 115-b may receive, an indication of (e.g., configuration information indicating) one or more configurations for generating a prediction for RLF of a link between the UE 115-b and the network entity 105-b as described with reference to FIG. 2. In some examples, the UE 115-b may transmit capability signaling indicating that the UE 115-b is capable of performing prediction for an RLF condition, prediction of measurement(s), or prediction indication (e.g., prediction reporting). The configuration indication may be output or received in response to the capability signaling in some approaches.

At 410, the network entity 105-b may output one or more reference signals to the UE 115-b. For example, the network entity 105-b may transmit, or the UE 115-b may receive, one or more reference signals for generating one or more measurements of the one or more reference signals as described with reference to FIG. 2 or FIG. 3.

At 415, the UE 115-b may generate one or more measurements based on the one or more reference signals. For example, the UE 115-b may determine one or more RSRPs or other measurements as described with reference to FIG. 2 or FIG. 3.

At 420, the UE 115-b may generate one or more predictions based on the one or more measurements and the configuration indication. For example, the UE 115-b may generate one or more predicted probabilities of RLF, one or more predicted measurements, or one or more predicted times of RLF as described with reference to FIG. 2 or FIG. 3.

At 425, the UE 115-b may perform an evaluation. For example, the UE 115-b may determine whether the measurement(s), predicted measurement(s), or predicted probability (ies) of RLF satisfy one or more thresholds or conditions as described with reference to FIG. 2 or FIG. 3.

At 430, the UE 115-b may transmit, or the network entity 105-b may obtain, a prediction indication. For example, in response to determining that the one or more thresholds or conditions are satisfied, the UE 115-b may transmit an indication of the prediction as described with reference to FIG. 2 or FIG. 3.

At 435, the network entity 105-b may output, or the UE 115-b may receive, a measurement configuration. For example, the UE 115-b may receive a measurement configuration to measure one or more signals corresponding to one or more candidate beams or candidate cells as described with reference to FIG. 2 or FIG. 3.

At 440, the network entity 105-b may output, or the UE 115-b may receive, one or more cell configurations. For example, the network entity 105-b may output one or more cell configurations for performing handover of the UE 115-b as described with reference to FIG. 2 or FIG. 3.

FIG. 5 shows an example of a block diagram of a machine learning process 500 that supports signaling for RLF predictions in accordance with one or more aspects of the present disclosure. The machine learning process 500 may be implemented at a UE 115, a UE 115-a, a UE 115-b, or another UE as described with reference to FIGS. 1 through 4.

The machine learning process 500 may include a machine learning algorithm 510. In some examples, one or more of the AI models described herein may be structured in accordance with the machine learning algorithm 510 for RLF probability prediction, measurement prediction, or other AI functionality described herein. As illustrated, the machine learning algorithm 510 may be an example of a neural network, such as a FF or DFF neural network, a RNN, a LSTM neural network, or any other type of neural network. However, any other machine learning algorithms may be supported. For example, the machine learning algorithm 510 may implement a nearest neighbor algorithm, a linear regression algorithm, a Naïve Bayes algorithm, a random forest algorithm, or any other machine learning algorithm. Furthermore, the machine learning process 500 may involve supervised learning, unsupervised learning, semi-supervised learning, reinforcement learning, or any combination thereof.

The machine learning algorithm 510 may include an input layer 515, one or more hidden layers 520, and an output layer 525. In a fully connected neural network with one hidden layer 520, each hidden layer node 535 may receive a value from each input layer node 530 (e.g., input layer node 530-a, input layer node 530-b, input layer node 530-c, another input layer node(s), or any combination thereof) as input, where each input may be weighted. These neural network weights may be based on a cost function that is revised during training of the machine learning algorithm 510. Similarly, each output layer node 540 (e.g., output layer node 540-a, output layer node 540-b, output layer node 540-c, another output layer node(s), or any combination thereof) may receive a value from each hidden layer node 535 (e.g., hidden layer node 535-a, hidden layer node 535-b, hidden layer node 535-c, hidden layer node 535-d, another hidden layer node(s), or any combination thereof) as input, where the inputs are weighted. If post-deployment training (e.g., online training) is supported, memory may be allocated to store errors or gradients for reverse matrix multiplication. These errors or gradients may support updating the machine learning algorithm 510 based on output feedback. Training the machine learning algorithm 510 may support computation of the weights (e.g., connecting the input layer nodes 530 to the hidden layer nodes 535 and the hidden layer nodes 535 to the output layer nodes 540) to map an input pattern to a desired output outcome. This training may result in a machine learning algorithm 510 based on the historic application data and data transfer for a network entity 105 or UE 115.

In some examples, input values 505 may be sent to the machine learning algorithm 510 for processing. In some examples, preprocessing may be performed according to a sequence of operations on the input values 505 such that the input values 505 may be in a format that is compatible with the machine learning algorithm 510. The input values 505 may be converted into a set of k input layer nodes 530 at the input layer 515. In some cases, different measurements may be input at different input layer nodes 530 of the input layer 515. Some input layer nodes 530 may be assigned default values (e.g., values of 0) if the quantity of input layer nodes 530 exceeds the quantity of inputs corresponding to the input values 505. As illustrated, the input layer 515 may include three input layer nodes 530-a, 530-b, and 530-c. However, it is to be understood that the input layer 515 may include any quantity of input layer nodes 530 (e.g., 20 input nodes).

The machine learning algorithm 510 may convert the input layer 515 to a hidden layer 520 based on a quantity of input-to-hidden weights between the k input layer nodes 530 and the n hidden layer nodes 535. The machine learning algorithm 510 may include any quantity of hidden layers 520 as intermediate steps between the input layer 515 and the output layer 525. Additionally, each hidden layer 520 may include any quantity of nodes. For example, as illustrated, the hidden layer 520 may include four hidden layer nodes 535-a, 535-b, 535-c, and 535-d. However, it is to be understood that the hidden layer 520 may include any quantity of hidden layer nodes 535 (e.g., 10 input nodes). In a fully connected neural network, each node in a layer may be based on each node in the previous layer. For example, the value of hidden layer node 535-a may be based on the values of input layer nodes 530-a, 530-b, and 530-c (e.g., with different weights applied to each node value).

The machine learning algorithm 510 may determine values for the output layer nodes 540 of the output layer 525 following one or more hidden layers 520. For example, the machine learning algorithm 510 may convert the hidden layer 520 to the output layer 525 based on a quantity of hidden-to-output weights between the n hidden layer nodes 535 and the m output layer nodes 540. In some cases, n=m. Each output layer node 540 may correspond to a different output value 545 of the machine learning algorithm 510. As illustrated, the machine learning algorithm 510 may include three output layer nodes 540-a, 540-b, and 540-c, supporting three different threshold values. However, it is to be understood that the output layer 525 may include any quantity of output layer nodes 540. In some examples, post-processing may be performed on the output values 545 according to a sequence of operations such that the output values 545 may be in a format that is compatible with reporting the output values 545. One or more of the AI models described herein may be implemented in accordance with the machine learning algorithm 510.

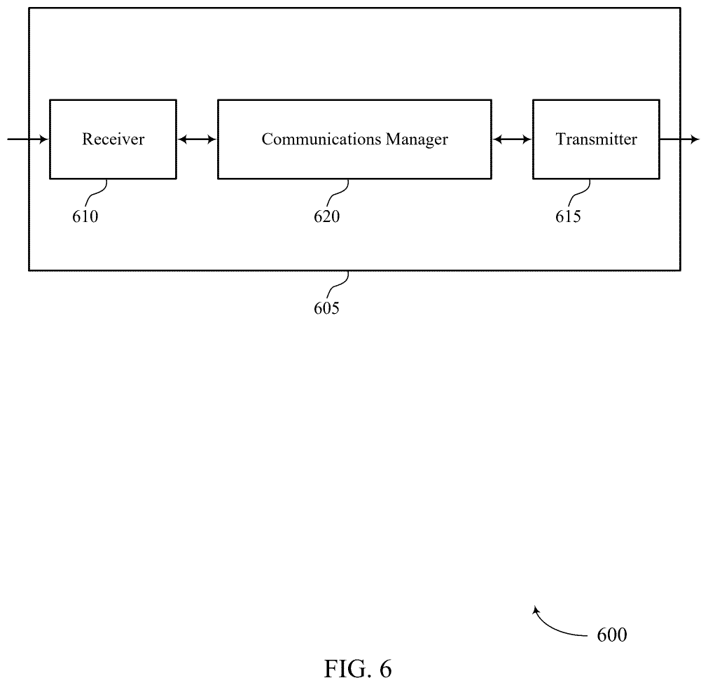

FIG. 6 shows a block diagram 600 of a device 605 that supports signaling for RLF predictions in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling for RLF predictions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling for RLF predictions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of signaling for RLF predictions as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, from a network entity, configuration information indicating at least one configuration for generating a prediction for RLF of a link between the UE and the network entity. The communications manager 620 is capable of, configured to, or operable to support a means for receiving, from the network entity, a signal for generating a measurement of the signal. The communications manager 620 is capable of, configured to, or operable to support a means for transmitting, to the network entity, an indication of the prediction for RLF of the link between the UE and the network entity, where the prediction is generated based on the measurement of the signal and an AI model.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources.

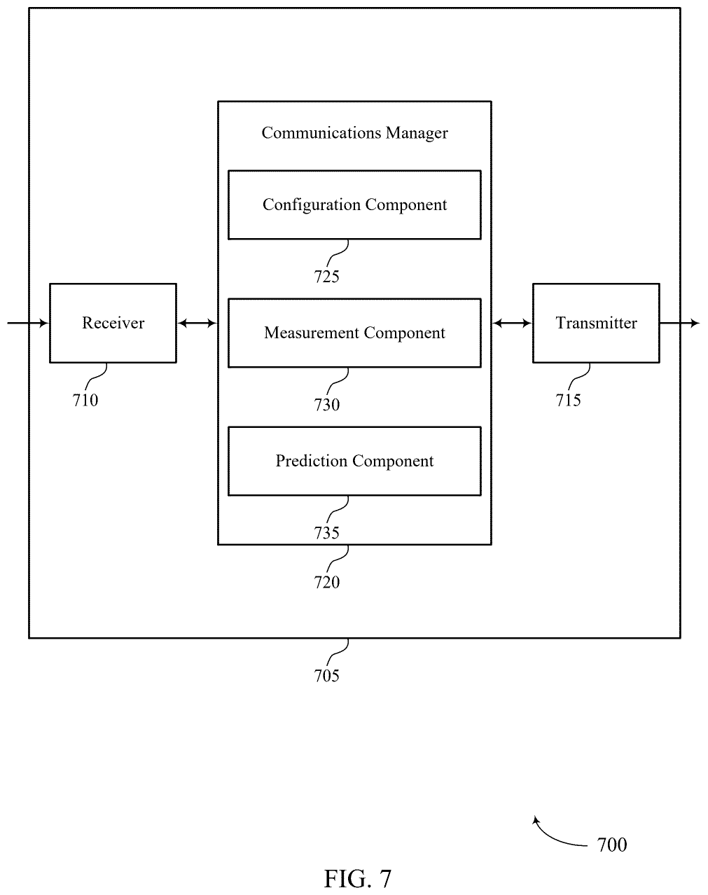

FIG. 7 shows a block diagram 700 of a device 705 that supports signaling for RLF predictions in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling for RLF predictions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling for RLF predictions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling for RLF predictions as described herein. For example, the communications manager 720 may include a configuration component 725, a measurement component 730, a prediction component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The configuration component 725 is capable of, configured to, or operable to support a means for receiving, from a network entity, configuration information indicating at least one configuration for generating a prediction for RLF of a link between the UE and the network entity. The measurement component 730 is capable of, configured to, or operable to support a means for receiving, from the network entity, a signal for generating a measurement of the signal. The prediction component 735 is capable of, configured to, or operable to support a means for transmitting, to the network entity, an indication of the prediction for RLF of the link between the UE and the network entity, where the prediction is generated based on the measurement of the signal and an AI model.

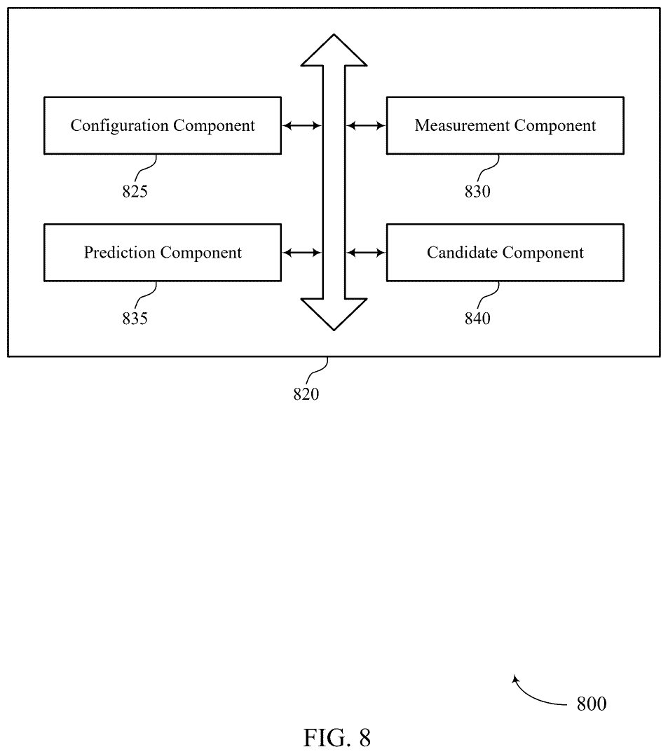

FIG. 8 shows a block diagram 800 of a communications manager 820 that supports signaling for RLF predictions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of signaling for RLF predictions as described herein. For example, the communications manager 820 may include a configuration component 825, a measurement component 830, a prediction component 835, a candidate component 840, or any combination thereof. Each of these components, or components or subcomponents thereof (e.g., one or more processors, one or more memories), may communicate, directly or indirectly, with one another (e.g., via one or more buses).

The configuration component 825 is capable of, configured to, or operable to support a means for receiving, from a network entity, configuration information indicating at least one configuration for generating a prediction for RLF of a link between the UE and the network entity. The measurement component 830 is capable of, configured to, or operable to support a means for receiving, from the network entity, a signal for generating a measurement of the signal. The prediction component 835 is capable of, configured to, or operable to support a means for transmitting, to the network entity, an indication of the prediction for RLF of the link between the UE and the network entity, where the prediction is generated based on the measurement of the signal and an AI model.

In some examples, the at least one configuration for generating the prediction for RLF includes a time of the prediction for RLF, a threshold for a score based on a probability of RLF, a threshold for the measurement of the signal, or a combination thereof.

In some examples, to support transmitting the indication of the prediction, the prediction component 835 is capable of, configured to, or operable to support a means for transmitting, for the time of the prediction, the indication of the prediction based on a first satisfaction of the threshold for the score based on the probability of RLF and a second satisfaction of the threshold for the measurement of the signal.

In some examples, the at least one configuration includes a first configuration for a first quantity of candidate cells and a second configuration for a second quantity of candidate cells. In some examples, the first quantity of candidate cells is less than the second quantity of candidate cells.

In some examples, the first configuration includes a first time of the prediction for RLF, a first threshold for a score based on a probability of RLF, and a first threshold for the measurement of the signal. In some examples, the second configuration includes a second time of the prediction for RLF and a second threshold for the score based on the probability of RLF.

In some examples, the first time of the prediction of the first configuration is greater than the second time of the prediction of the second configuration.

In some examples, the indication of the prediction for RLF includes a predicted time for RLF, information associated with a distribution of predicted time for RLF, or a combination thereof.

In some examples, the prediction component 835 is capable of, configured to, or operable to support a means for transmitting measurement information indicating the measurement of the signal, prediction information indicating a predicted measurement for a future occurrence of RLF, or a combination thereof.

In some examples, the candidate component 840 is capable of, configured to, or operable to support a means for transmitting, in a message including the indication of the prediction for RLF, information indicating one or more candidate cells for handover, and one or more predicted measurements for each of the one or more candidate cells.

In some examples, the candidate component 840 is capable of, configured to, or operable to support a means for receiving, from the network entity in response to transmitting the message, configuration data indicating a configuration for measurement of one or more additional candidate cells.

In some examples, the candidate component 840 is capable of, configured to, or operable to support a means for receiving, from the network entity in response to the message, one or more configurations corresponding to at least one candidate cell for handover.

In some examples, the prediction component 835 is capable of, configured to, or operable to support a means for transmitting, to the network entity, a second indication of a second prediction for RLF of the link between the UE and the network entity, where the indication of the prediction for RLF and the second indication of the second prediction for RLF are transmitted in accordance with a period.

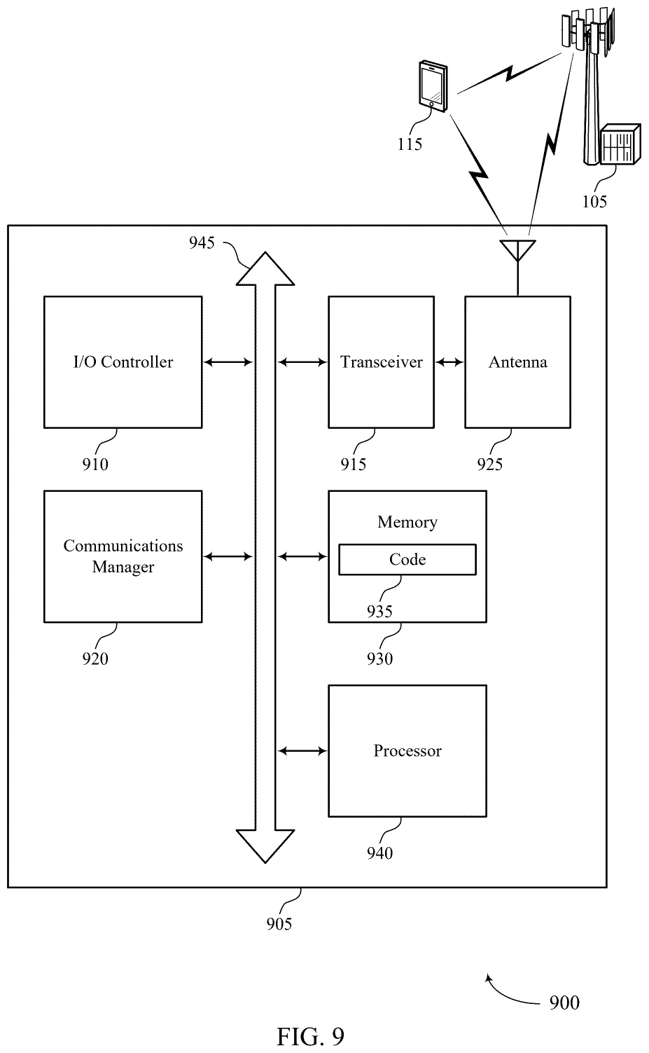

FIG. 9 shows a diagram of a system 900 including a device 905 that supports signaling for RLF predictions in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting signaling for RLF predictions). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

For example, the communications manager 920 is capable of, configured to, or operable to support a means for receiving, from a network entity, configuration information indicating at least one configuration for generating a prediction for RLF of a link between the UE and the network entity. The communications manager 920 is capable of, configured to, or operable to support a means for receiving, from the network entity, a signal for generating a measurement of the signal. The communications manager 920 is capable of, configured to, or operable to support a means for transmitting, to the network entity, an indication of the prediction for RLF of the link between the UE and the network entity, where the prediction is generated based on the measurement of the signal and an AI model.

By including or configuring the communications manager 920 in accordance with examples as described herein, the device 905 may support techniques for improved communication reliability, reduced latency, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of signaling for RLF predictions as described herein, or the at least one processor 940 and the at least one memory 930 may be otherwise configured to, individually or collectively, perform or support such operations.

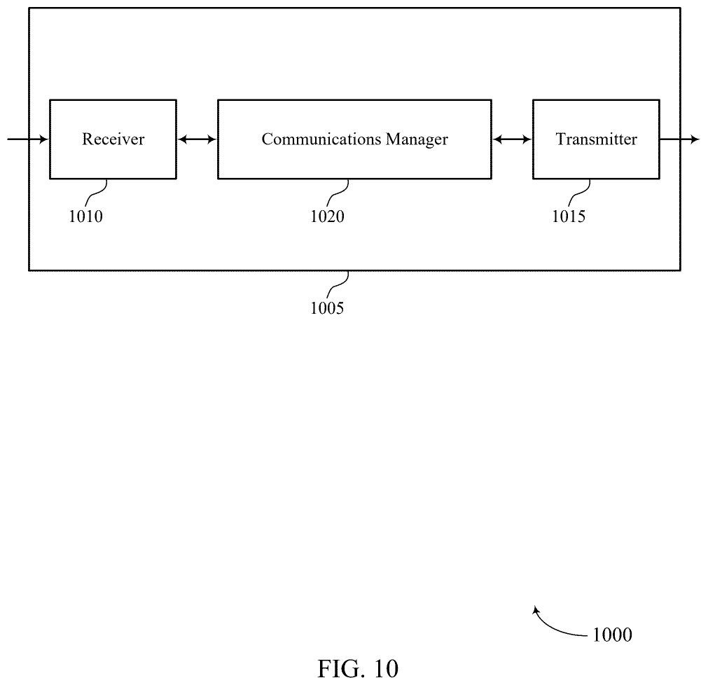

FIG. 10 shows a block diagram 1000 of a device 1005 that supports signaling for RLF predictions in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of signaling for RLF predictions as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for outputting, to a UE, configuration information indicating at least one configuration for generating a prediction for RLF of a link between the UE and the network entity. The communications manager 1020 is capable of, configured to, or operable to support a means for outputting, to the UE, a signal for generating a measurement of the signal. The communications manager 1020 is capable of, configured to, or operable to support a means for obtaining, from the UE, an indication of the prediction for RLF of the link between the UE and the network entity, where the prediction is generated based on the measurement of the signal and an AI model.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources.

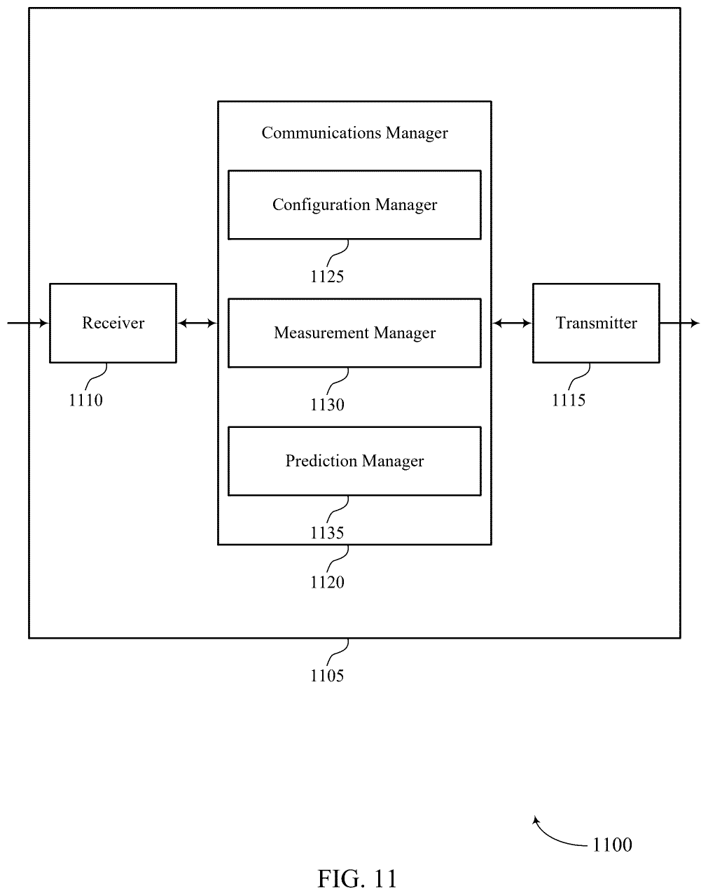

FIG. 11 shows a block diagram 1100 of a device 1105 that supports signaling for RLF predictions in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of signaling for RLF predictions as described herein. For example, the communications manager 1120 may include a configuration manager 1125, a measurement manager 1130, a prediction manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The configuration manager 1125 is capable of, configured to, or operable to support a means for outputting, to a UE, configuration information indicating at least one configuration for generating a prediction for RLF of a link between the UE and the network entity. The measurement manager 1130 is capable of, configured to, or operable to support a means for outputting, to the UE, a signal for generating a measurement of the signal. The prediction manager 1135 is capable of, configured to, or operable to support a means for obtaining, from the UE, an indication of the prediction for RLF of the link between the UE and the network entity, where the prediction is generated based on the measurement of the signal and an AI model.

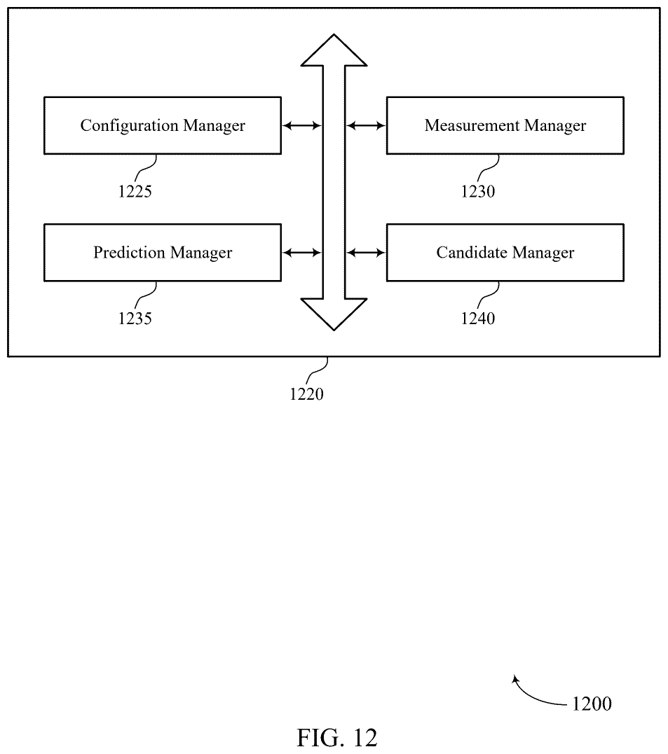

FIG. 12 shows a block diagram 1200 of a communications manager 1220 that supports signaling for RLF predictions in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of signaling for RLF predictions as described herein. For example, the communications manager 1220 may include a configuration manager 1225, a measurement manager 1230, a prediction manager 1235, a candidate manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The configuration manager 1225 is capable of, configured to, or operable to support a means for outputting, to a UE, configuration information indicating at least one configuration for generating a prediction for RLF of a link between the UE and the network entity. The measurement manager 1230 is capable of, configured to, or operable to support a means for outputting, to the UE, a signal for generating a measurement of the signal. The prediction manager 1235 is capable of, configured to, or operable to support a means for obtaining, from the UE, an indication of the prediction for RLF of the link between the UE and the network entity, where the prediction is generated based on the measurement of the signal and an AI model.

In some examples, the at least one configuration for generating the prediction for RLF includes a time of the prediction for RLF, a threshold for a score based on a probability of RLF, a threshold for the measurement of the signal, or a combination thereof.

In some examples, the at least one configuration includes a first configuration for a first quantity of candidate cells and a second configuration for a second quantity of candidate cells. In some examples, the first quantity of candidate cells is less than the second quantity of candidate cells.

In some examples, the first configuration includes a first time of the prediction for RLF, a first threshold for a score based on a probability of RLF, and a first threshold for the measurement of the signal. In some examples, the second configuration includes a second time of the prediction for RLF and a second threshold for the score based on the probability of RLF.

In some examples, the candidate manager 1240 is capable of, configured to, or operable to support a means for obtaining, in a message including the indication of the prediction for RLF, information indicating one or more candidate cells for handover, and one or more predicted measurements for each of the one or more candidate cells.

In some examples, the candidate manager 1240 is capable of, configured to, or operable to support a means for outputting, to the UE in response to the message, configuration data indicating a configuration for measurement of one or more additional candidate cells.

In some examples, the candidate manager 1240 is capable of, configured to, or operable to support a means for outputting, to the one or more candidate cells in response to the message, information associated with a potential handover of the UE to the one or more candidate cells. In some examples, the candidate manager 1240 is capable of, configured to, or operable to support a means for outputting, to the UE in response to the message, one or more configurations corresponding to at least one candidate cell for handover.

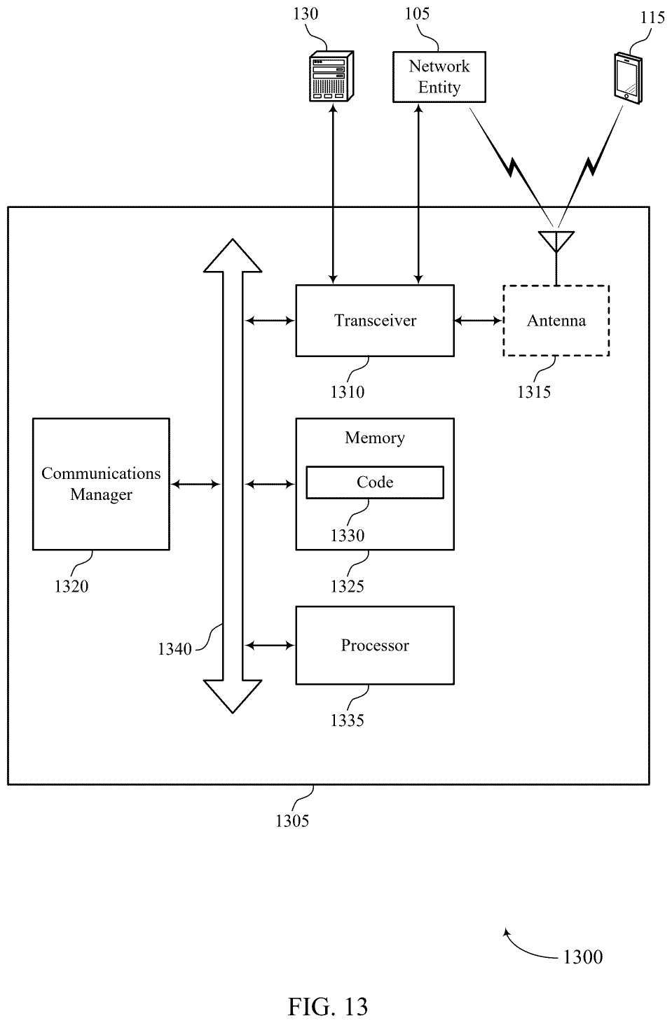

FIG. 13 shows a diagram of a system 1300 including a device 1305 that supports signaling for RLF predictions in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting signaling for RLF predictions). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105 and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

For example, the communications manager 1320 is capable of, configured to, or operable to support a means for outputting, to a UE, configuration information indicating at least one configuration for generating a prediction for RLF of a link between the UE and the network entity. The communications manager 1320 is capable of, configured to, or operable to support a means for outputting, to the UE, a signal for generating a measurement of the signal. The communications manager 1320 is capable of, configured to, or operable to support a means for obtaining, from the UE, an indication of the prediction for RLF of the link between the UE and the network entity, where the prediction is generated based on the measurement of the signal and an AI model.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of signaling for RLF predictions as described herein, or the at least one processor 1335 and the at least one memory 1325 may be otherwise configured to, individually or collectively, perform or support such operations.

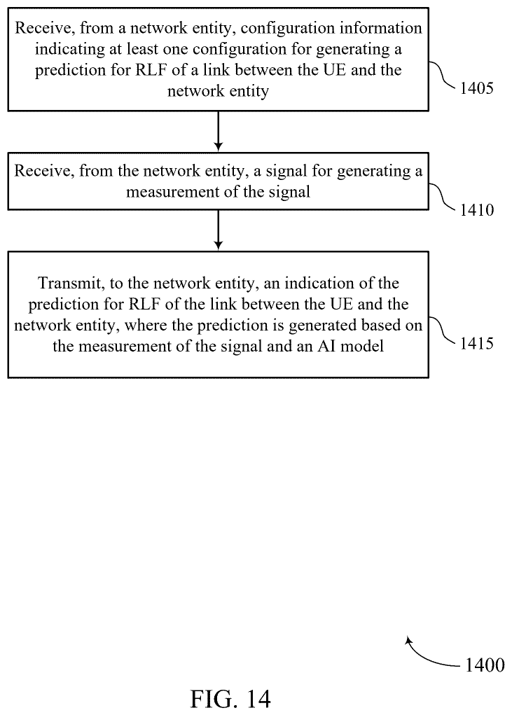

FIG. 14 shows a flowchart illustrating a method 1400 that supports signaling for RLF predictions in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, configuration information indicating at least one configuration for generating a prediction for RLF of a link between the UE and the network entity. The operations of 1405 may be performed in accordance with examples as disclosed herein. In some examples, aspects of the operations of 1405 may be performed by a configuration component 825 as described with reference to FIG. 8. Additionally, or alternatively, means for performing 1405 may, but not necessarily, include, for example, antenna 925, transceiver 915, communications manager 920, memory 930 (including code 935), processor 940 or bus 945.

At 1410, the method may include receiving, from the network entity, a signal for generating a measurement of the signal. The operations of 1410 may be performed in accordance with examples as disclosed herein. In some examples, aspects of the operations of 1410 may be performed by a measurement component 830 as described with reference to FIG. 8. Additionally, or alternatively, means for performing 1410 may, but not necessarily, include, for example, antenna 925, transceiver 915, communications manager 920, memory 930 (including code 935), processor 940 or bus 945.

At 1415, the method may include transmitting, to the network entity, an indication of the prediction for RLF of the link between the UE and the network entity, where the prediction is generated based on the measurement of the signal and an AI model. The operations of 1415 may be performed in accordance with examples as disclosed herein. In some examples, aspects of the operations of 1415 may be performed by a prediction component 835 as described with reference to FIG. 8. Additionally, or alternatively, means for performing 1415 may, but not necessarily, include, for example, antenna 925, transceiver 915, communications manager 920, memory 930 (including code 935), processor 940 or bus 945.

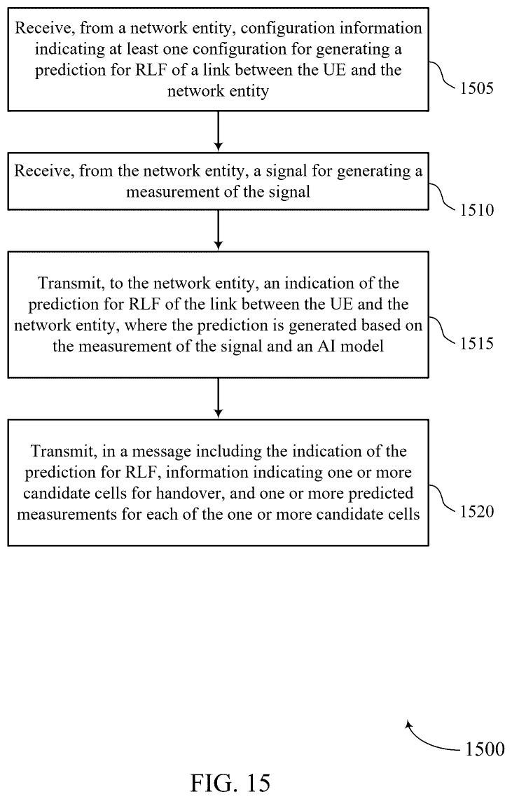

FIG. 15 shows a flowchart illustrating a method 1500 that supports signaling for RLF predictions in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, configuration information indicating at least one configuration for generating a prediction for RLF of a link between the UE and the network entity. The operations of 1505 may be performed in accordance with examples as disclosed herein. In some examples, aspects of the operations of 1505 may be performed by a configuration component 825 as described with reference to FIG. 8. Additionally, or alternatively, means for performing 1505 may, but not necessarily, include, for example, antenna 925, transceiver 915, communications manager 920, memory 930 (including code 935), processor 940 or bus 945.

At 1510, the method may include receiving, from the network entity, a signal for generating a measurement of the signal. The operations of 1510 may be performed in accordance with examples as disclosed herein. In some examples, aspects of the operations of 1510 may be performed by a measurement component 830 as described with reference to FIG. 8. Additionally, or alternatively, means for performing 1510 may, but not necessarily, include, for example, antenna 925, transceiver 915, communications manager 920, memory 930 (including code 935), processor 940 or bus 945.

At 1515, the method may include transmitting, to the network entity, an indication of the prediction for RLF of the link between the UE and the network entity, where the prediction is generated based on the measurement of the signal and an AI model. The operations of 1515 may be performed in accordance with examples as disclosed herein. In some examples, aspects of the operations of 1515 may be performed by a prediction component 835 as described with reference to FIG. 8. Additionally, or alternatively, means for performing 1515 may, but not necessarily, include, for example, antenna 925, transceiver 915, communications manager 920, memory 930 (including code 935), processor 940 or bus 945.

At 1520, the method may include transmitting, in a message including the indication of the prediction for RLF, information indicating one or more candidate cells for handover, and one or more predicted measurements for each of the one or more candidate cells. The operations of 1520 may be performed in accordance with examples as disclosed herein. In some examples, aspects of the operations of 1520 may be performed by a candidate component 840 as described with reference to FIG. 8. Additionally, or alternatively, means for performing 1520 may, but not necessarily, include, for example, antenna 925, transceiver 915, communications manager 920, memory 930 (including code 935), processor 940 or bus 945.

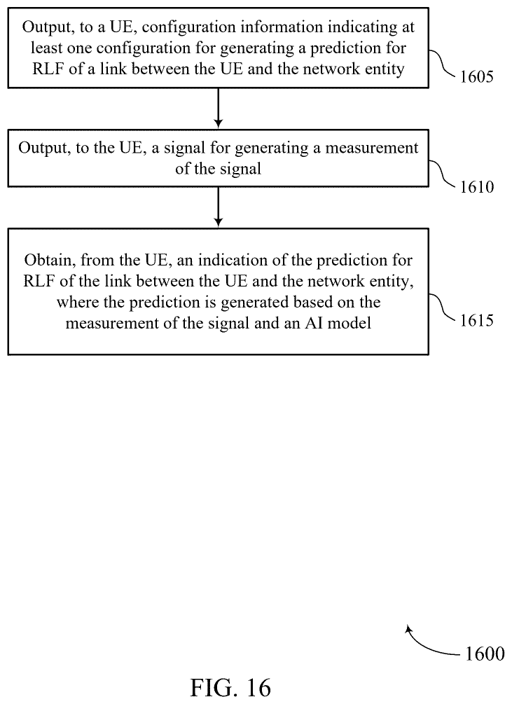

FIG. 16 shows a flowchart illustrating a method 1600 that supports signaling for RLF predictions in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a UE, configuration information indicating at least one configuration for generating a prediction for RLF of a link between the UE and the network entity. The operations of 1605 may be performed in accordance with examples as disclosed herein. In some examples, aspects of the operations of 1605 may be performed by a configuration manager 1225 as described with reference to FIG. 12. Additionally, or alternatively, means for performing 1605 may, but not necessarily, include, for example, antenna 1315, transceiver 1310, communications manager 1320, memory 1325 (including code 1330), processor 1335 or bus 1340.

At 1610, the method may include outputting, to the UE, a signal for generating a measurement of the signal. The operations of 1610 may be performed in accordance with examples as disclosed herein. In some examples, aspects of the operations of 1610 may be performed by a measurement manager 1230 as described with reference to FIG. 12. Additionally, or alternatively, means for performing 1610 may, but not necessarily, include, for example, antenna 1315, transceiver 1310, communications manager 1320, memory 1325 (including code 1330), processor 1335 or bus 1340.

At 1615, the method may include obtaining, from the UE, an indication of the prediction for RLF of the link between the UE and the network entity, where the prediction is generated based on the measurement of the signal and an AI model. The operations of 1615 may be performed in accordance with examples as disclosed herein. In some examples, aspects of the operations of 1615 may be performed by a prediction manager 1235 as described with reference to FIG. 12. Additionally, or alternatively, means for performing 1615 may, but not necessarily, include, for example, antenna 1315, transceiver 1310, communications manager 1320, memory 1325 (including code 1330), processor 1335 or bus 1340.

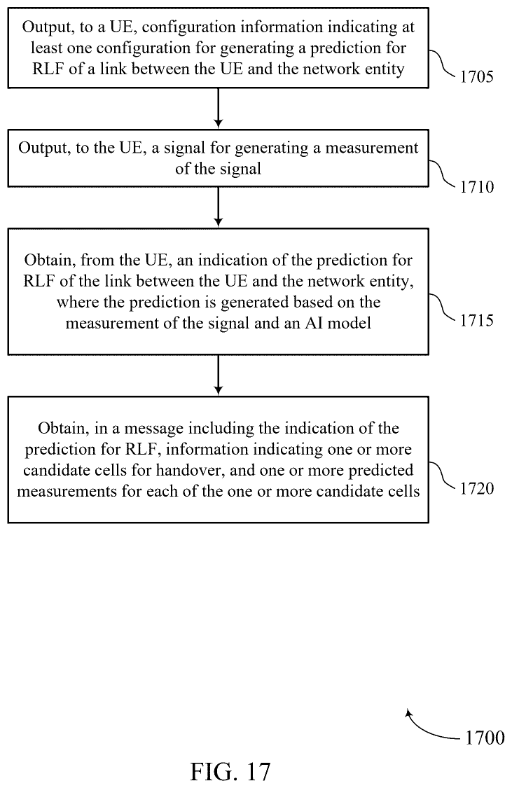

FIG. 17 shows a flowchart illustrating a method 1700 that supports signaling for RLF predictions in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, configuration information indicating at least one configuration for generating a prediction for RLF of a link between the UE and the network entity. The operations of 1705 may be performed in accordance with examples as disclosed herein. In some examples, aspects of the operations of 1705 may be performed by a configuration manager 1225 as described with reference to FIG. 12. Additionally, or alternatively, means for performing 1705 may, but not necessarily, include, for example, antenna 1315, transceiver 1310, communications manager 1320, memory 1325 (including code 1330), processor 1335 or bus 1340.

At 1710, the method may include outputting, to the UE, a signal for generating a measurement of the signal. The operations of 1710 may be performed in accordance with examples as disclosed herein. In some examples, aspects of the operations of 1710 may be performed by a measurement manager 1230 as described with reference to FIG. 12. Additionally, or alternatively, means for performing 1710 may, but not necessarily, include, for example, antenna 1315, transceiver 1310, communications manager 1320, memory 1325 (including code 1330), processor 1335 or bus 1340.

At 1715, the method may include obtaining, from the UE, an indication of the prediction for RLF of the link between the UE and the network entity, where the prediction is generated based on the measurement of the signal and an AI model. The operations of 1715 may be performed in accordance with examples as disclosed herein. In some examples, aspects of the operations of 1715 may be performed by a prediction manager 1235 as described with reference to FIG. 12. Additionally, or alternatively, means for performing 1715 may, but not necessarily, include, for example, antenna 1315, transceiver 1310, communications manager 1320, memory 1325 (including code 1330), processor 1335 or bus 1340.

At 1720, the method may include obtaining, in a message including the indication of the prediction for RLF, information indicating one or more candidate cells for handover, and one or more predicted measurements for each of the one or more candidate cells. The operations of 1720 may be performed in accordance with examples as disclosed herein. In some examples, aspects of the operations of 1720 may be performed by a candidate manager 1240 as described with reference to FIG. 12. Additionally, or alternatively, means for performing 1720 may, but not necessarily, include, for example, antenna 1315, transceiver 1310, communications manager 1320, memory 1325 (including code 1330), processor 1335 or bus 1340.

The following provides an overview of aspects of the present disclosure:

Aspect 1: A method for wireless communications at a UE, comprising: receiving, from a network entity, configuration information indicating at least one configuration for generating a prediction for RLF of a link between the UE and the network entity; receiving, from the network entity, a signal for generating a measurement of the signal; and transmitting, to the network entity, an indication of the prediction for RLF of the link between the UE and the network entity, wherein the prediction is generated based at least in part on the measurement of the signal and an AI model.

Aspect 2: The method of aspect 1, wherein the at least one configuration for generating the prediction for RLF comprises a time of the prediction for RLF, a threshold for a score based at least in part on a probability of RLF, a threshold for the measurement of the signal, or a combination thereof.

Aspect 3: The method of aspect 2, wherein transmitting the indication of the prediction comprises: transmitting, for the time of the prediction, the indication of the prediction based at least in part on a first satisfaction of the threshold for the score based at least in part on the probability of RLF and a second satisfaction of the threshold for the measurement of the signal.

Aspect 4: The method of any of aspects 1 through 3, wherein the at least one configuration comprises a first configuration for a first quantity of candidate cells and a second configuration for a second quantity of candidate cells, the first quantity of candidate cells is less than the second quantity of candidate cells.

Aspect 5: The method of aspect 4, wherein the first configuration comprises a first time of the prediction for RLF, a first threshold for a score based at least in part on a probability of RLF, and a first threshold for the measurement of the signal, and the second configuration comprises a second time of the prediction for RLF and a second threshold for the score based at least in part on the probability of RLF.

Aspect 6: The method of aspect 5, wherein the first time of the prediction of the first configuration is greater than the second time of the prediction of the second configuration.

Aspect 7: The method of any of aspects 1 through 6, wherein the indication of the prediction for RLF comprises a predicted time for RLF, information associated with a distribution of predicted time for RLF, or a combination thereof.

Aspect 8: The method of any of aspects 1 through 7, further comprising: transmitting measurement information indicating the measurement of the signal, an indication of a predicted measurement for a future occurrence of RLF, or a combination thereof.

Aspect 9: The method of any of aspects 1 through 8, further comprising: transmitting, in a message including the indication of the prediction for RLF, information indicating one or more candidate cells for handover, and one or more predicted measurements for each of the one or more candidate cells.

Aspect 10: The method of aspect 9, further comprising: receiving, from the network entity in response to transmitting the message, configuration data indicating a configuration for measurement of one or more additional candidate cells.

Aspect 11: The method of any of aspects 9 through 10, further comprising: receiving, from the network entity in response to the message, one or more configurations corresponding to at least one candidate cell for handover.

Aspect 12: The method of any of aspects 1 through 11, further comprising: transmitting, to the network entity, a second indication of a second prediction for RLF of the link between the UE and the network entity, wherein the indication of the prediction for RLF and the second indication of the second prediction for RLF are transmitted in accordance with a period.

Aspect 13: A method for wireless communications at a network entity, comprising: outputting, to a UE, configuration information indicating at least one configuration for generating a prediction for RLF of a link between the UE and the network entity; outputting, to the UE, a signal for generating a measurement of the signal; and obtaining, from the UE, an indication of the prediction for RLF of the link between the UE and the network entity, wherein the prediction is generated based at least in part on the measurement of the signal and an AI model.

Aspect 14: The method of aspect 13, wherein the at least one configuration for generating the prediction for RLF comprises a time of the prediction for RLF, a threshold for a score based at least in part on a probability of RLF, a threshold for the measurement of the signal, or a combination thereof.

Aspect 15: The method of any of aspects 13 through 14, wherein the at least one configuration comprises a first configuration for a first quantity of candidate cells and a second configuration for a second quantity of candidate cells, the first quantity of candidate cells is less than the second quantity of candidate cells.

Aspect 16: The method of aspect 15, wherein the first configuration comprises a first time of the prediction for RLF, a first threshold for a score based at least in part on a probability of RLF, and a first threshold for the measurement of the signal, and the second configuration comprises a second time of the prediction for RLF and a second threshold for the score based at least in part on the probability of RLF.

Aspect 17: The method of any of aspects 13 through 16, further comprising: obtaining, in a message including the indication of the prediction for RLF, information indicating one or more candidate cells for handover, and one or more predicted measurements for each of the one or more candidate cells.

Aspect 18: The method of aspect 17, further comprising: outputting, to the UE in response to the message, configuration data indicating a configuration for measurement of one or more additional candidate cells.

Aspect 19: The method of any of aspects 17 through 18, further comprising: outputting, to the one or more candidate cells in response to the message, information associated with a potential handover of the UE to the one or more candidate cells; and outputting, to the UE in response to the message, one or more configurations corresponding to at least one candidate cell for handover.

Aspect 20: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 12.

Aspect 21: A UE comprising at least one means for performing a method of any of aspects 1 through 12.

Aspect 22: A non-transitory computer-readable medium storing code the code comprising instructions executable by one or more processors to perform a method of any of aspects 1 through 12.

Aspect 23: A network entity comprising one or more memories storing processor-executable code, and one or more processors coupled with the one or more memories and individually or collectively operable to execute the code to cause the network entity to perform a method of any of aspects 13 through 19.

Aspect 24: A network entity comprising at least one means for performing a method of any of aspects 13 through 19.

Aspect 25: A non-transitory computer-readable medium storing code the code comprising instructions executable by one or more processors to perform a method of any of aspects 13 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
one or more memories storing processor-executable code;
a transceiver; and
one or more processors coupled with the one or more memories and the transceiver, the one or more processors individually or collectively operable to execute the code to cause the UE to:
receive, via the transceiver from a network entity, configuration information indicating at least one configuration for generating a prediction for radio link failure of a link between the UE and the network entity;
receive, via the transceiver from the network entity, a signal for generating a measurement of the signal; and
transmit, via the transceiver to the network entity, an indication of the prediction for radio link failure of the link between the UE and the network entity, wherein the prediction is generated based at least in part on the measurement of the signal and an artificial intelligence model.

2. The UE of claim 1, wherein the at least one configuration for generating the prediction for radio link failure comprises a time of the prediction for radio link failure, a threshold for a score based at least in part on a probability of radio link failure, a threshold for the measurement of the signal, or a combination thereof.

3. The UE of claim 2, wherein, to transmit the indication of the prediction, the one or more processors are individually or collectively operable to execute the code to cause the UE to:
transmit, via the transceiver, for the time of the prediction, the indication of the prediction based at least in part on a first satisfaction of the threshold for the score based at least in part on the probability of radio link failure and a second satisfaction of the threshold for the measurement of the signal.

4. The UE of claim 1, wherein:
the at least one configuration comprises a first configuration for a first quantity of candidate cells and a second configuration for a second quantity of candidate cells, and
the first quantity of candidate cells is less than the second quantity of candidate cells.

5. The UE of claim 4, wherein:
the first configuration comprises a first time of the prediction for radio link failure, a first threshold for a score based at least in part on a probability of radio link failure, and a first threshold for the measurement of the signal, and
the second configuration comprises a second time of the prediction for radio link failure and a second threshold for the score based at least in part on the probability of radio link failure.

6. The UE of claim 5, wherein the first time of the prediction of the first configuration is greater than the second time of the prediction of the second configuration.

7. The UE of claim 1, wherein the indication of the prediction for radio link failure comprises a predicted time for radio link failure, information associated with a distribution of predicted time for radio link failure, or a combination thereof.

8. The UE of claim 1, wherein the one or more processors are individually or collectively further operable to execute the code to cause the UE to:
transmit, via the transceiver, measurement information indicating the measurement of the signal, prediction information indicating a predicted measurement for a future occurrence of radio link failure, or a combination thereof.

9. The UE of claim 1, wherein the one or more processors are individually or collectively further operable to execute the code to cause the UE to:
transmit, via the transceiver, in a message including the indication of the prediction for radio link failure, information indicating one or more candidate cells for handover, and one or more predicted measurements for each of the one or more candidate cells.

10. The UE of claim 9, wherein the one or more processors are individually or collectively further operable to execute the code to cause the UE to:
receive, via the transceiver, from the network entity in response to transmitting the message, configuration data indicating a configuration for measurement of one or more additional candidate cells.

11. The UE of claim 9, wherein the one or more processors are individually or collectively further operable to execute the code to cause the UE to:
receive, via the transceiver, from the network entity in response to the message, one or more configurations corresponding to at least one candidate cell for handover.

12. The UE of claim 1, wherein the one or more processors are individually or collectively further operable to execute the code to cause the UE to:
transmit, via the transceiver to the network entity, a second indication of a second prediction for radio link failure of the link between the UE and the network entity, wherein the indication of the prediction for radio link failure and the second indication of the second prediction for radio link failure are transmitted in accordance with a period.

13. A network entity for wireless communications, comprising:
one or more memories storing processor-executable code; and
one or more processors coupled with the one or more memories and individually or collectively operable to execute the code to cause the network entity to:
output, to a user equipment (UE), configuration information indicating at least one configuration for generating a prediction for radio link failure of a link between the UE and the network entity;
output, to the UE, a signal for generating a measurement of the signal; and
obtain, from the UE, an indication of the prediction for radio link failure of the link between the UE and the network entity, wherein the prediction is generated based at least in part on the measurement of the signal and an artificial intelligence model.

14. The network entity of claim 13, wherein the at least one configuration for generating the prediction for radio link failure comprises a time of the prediction for radio link failure, a threshold for a score based at least in part on a probability of radio link failure, a threshold for the measurement of the signal, or a combination thereof.

15. The network entity of claim 13, wherein:
the at least one configuration comprises a first configuration for a first quantity of candidate cells and a second configuration for a second quantity of candidate cells, and
the first quantity of candidate cells is less than the second quantity of candidate cells.

16. The network entity of claim 15, wherein:
the first configuration comprises a first time of the prediction for radio link failure, a first threshold for a score based at least in part on a probability of radio link failure, and a first threshold for the measurement of the signal, and
the second configuration comprises a second time of the prediction for radio link failure and a second threshold for the score based at least in part on the probability of radio link failure.

17. The network entity of claim 13, wherein the one or more processors are individually or collectively further operable to execute the code to cause the network entity to:
obtain, in a message including the indication of the prediction for radio link failure, information indicating one or more candidate cells for handover, and one or more predicted measurements for each of the one or more candidate cells.

18. The network entity of claim 17, wherein the one or more processors are individually or collectively further operable to execute the code to cause the network entity to:
output, to the UE in response to the message, configuration data indicating a configuration for measurement of one or more additional candidate cells.

19. The network entity of claim 17, wherein the one or more processors are individually or collectively further operable to execute the code to cause the network entity to:
output, to the one or more candidate cells in response to the message, information associated with a potential handover of the UE to the one or more candidate cells; and
output, to the UE in response to the message, one or more configurations corresponding to at least one candidate cell for handover.

20. A method for wireless communications at a user equipment (UE), comprising:
receiving, from a network entity, configuration information indicating at least one configuration for generating a prediction for radio link failure of a link between the UE and the network entity;
receiving, from the network entity, a signal for generating a measurement of the signal; and
transmitting, to the network entity, an indication of the prediction for radio link failure of the link between the UE and the network entity, wherein the prediction is generated based at least in part on the measurement of the signal and an artificial intelligence model.
